(19) United States
(12) Patent Application Publication
(10) Pub. No.: US 2018/0056331 A1
(43) Pub. Date: Mar. 1, 2018

(54) Backflow Pan

(71) Applicants: Grant Young, Tulsa, OK (US); Thomas Young, Glenpool, OK (US)

(72) Inventors: Grant Young, Tulsa, OK (US); Thomas Young, Glenpool, OK (US)

(21) Appl. No.: 15/249,914

(22) Filed: Aug. 29, 2016

(51) Int. Cl. B07B 1/46; B07B 1/28

(52) U.S. Cl. CPC B07B 1/46; B07B 2201/04; B07B 1/28

(57) ABSTRACT

A pan for use in a shaker can have a first end and a second end with a length there between. The pan can have a bottom with a width, narrowing side portions, an upper opening, and upper sides separated by an upper transverse width. The upper transverse width can be wider than the width of the bottom and the narrowing side portions can connecting the upper sides to the bottom. The bottom can have a downward slant along the length between the first end and the second end.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to shakers for separating materials using a backflow pan.

### BACKGROUND OF THE INVENTION

Shakers or other vibrating screen devices can be used to separate solids from fluids. Some shakers have multiple screens for separating solids from fluid. The fluid can pass through the screen and the solids remain atop the screen to be conveyed off. Shakers which incorporate two screen surfaces having one screen surface positioned above a lower screen surface often can use a backflow pan to transport the flow of solids and liquids passing through the upper screen surface to be conveyed to the beginning of the lower screen surface.

Screens on vibratory shakers often utilize regular visual inspection to ensure the lower screen surface is in good condition. Checking the lower screen can be particularly important in some applications because the lower screen often removes the majority of the solids and usually makes a finer separation than the upper screen. Allowing solids to pass through damaged portions in the screen can result in downhole problems as well as maintenance problems.

Also as used in this application, “blinding” refers to the condition when a screen has lost much of its filtering capability due to the pores within the screen being plugged to the point of substantially interfering with fluid flow through the screen.

Most shakers with stacked screens utilize square shaped pans with the upper screen surface. However, a square pan often provides poor visibility of the lower screen under the pan. There is a need for a pan that provides greater visibility of the lower screen during visual inspections.

The instant invention, with its multiple embodiments as disclosed within this application, provides a pan that provides a line of sight to the lower screen that improves visual inspection of the lower screen. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. §1.56(a) exists.

All US patents and applications and all other published documents mentioned anywhere in this application are incorporated herein by reference in their entirety.

When not defined otherwise, in this application “length” is in the direction of the general flow of fluid in the pan and “width” is transverse to the general flow of fluid in the pan.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, a pan for use in a shaker has a first end and second end. The pan can have a bottom with a width, narrowing side portions, an upper opening, and upper sides separated by a transverse width with the transverse width being wider than the width of the bottom. The narrowing side portions can connect the upper sides to the bottom. The bottom can have a downward slant along the length between the first end and the second end.

In at least one embodiment, the upper sides partially form the upper opening and extend substantially vertically down to the narrowing side portions.

In at least one embodiment, the upper sides and the narrowing side portions are made of one piece construction.

In at least one embodiment, the length of the pan is greater than the length of the narrowing side portions.

In at least one embodiment, there are multiple narrowing side portions along the length of the pan.

In at least one embodiment, a shaker has at least two screens wherein a first screen is placed vertically above a second screen with a flowback pan disposed between the first screen and the second screen. The pan can have a bottom with a width, narrowing side portions, an upper opening, and upper sides separated by a transverse width wherein the transverse width is wider than the width of the bottom. The narrowing side portions can connect the upper sides to the bottom.

In at least one embodiment of the invention, the pan is constructed of a metal, a plastic, a ceramic, or any combination of these.

A screen that is “sequentially after” is a screen in the sequence that receives material (solid or fluid) from another screen in the sequence. A screen that is “sequentially before” is a screen in the sequence that transfers material (solid or fluid) to another screen in the sequence. Obviously if there are more than two screens in the sequential configuration at least one will be both “sequentially after” another screen and “sequentially before” another screen.

In at least one embodiment of the invention, the fluid is a water based fluid, an oil based fluid, a gelatinous based fluid, a plasma based fluid, or any combination thereof.

The patent application titled “Vibrating Screen Device” and having patent application Ser. No. 12/658,686 is incorporated by reference. The vibratory screen device of this previously filed patent application can be used in many embodiments disclosed herein.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a prior art front cross-sectional view of a pan within a shaker.

FIG. 2 is a front cross-sectional view of an improved pan within a shaker having an improved visibility design.

FIG. 3 is a perspective side cross-sectional view of an improved pan within a shaker having an improved visibility design.

FIG. 4 is a perspective view of an improved pan for use within a shaker having an improved visibility design.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. Unless otherwise stated, within this application the term “proximal” end of the pan is the end in which the fluid as a flow is introduced; the “distal” end of the pan is the end toward which the fluid exits the pan.

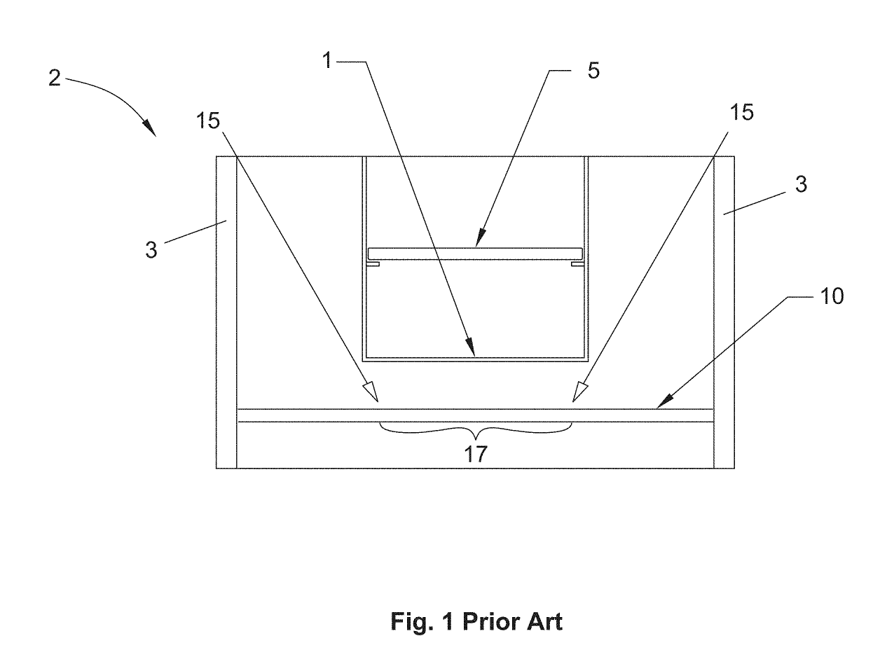

In FIG. 1 a Prior Art backflow pan 1 is illustrated within a shaker 2 in cross section. The pan 1 supports an upper screen 5 and a lower screen 10. As shown, the line of sight 15 does not allow a viewer to see a middle portion 17 of the lower screen 10. The line of sight here is limited by the shaker wall 3 of the shaker 2 and the backflow pan 1.

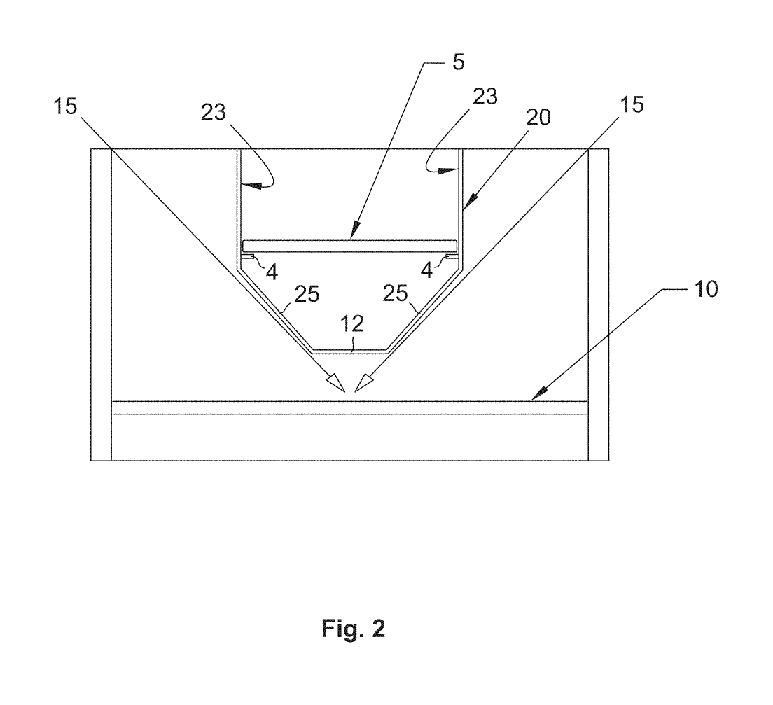

In FIG. 2 an improved backflow pan 20 is illustrated within a shaker 2 in cross section. The pan 20 has substantially vertical sides 23 and tapered sides 25 that angle toward one another such that the line of sight 15 has an unobstructed view of the middle of the lower screen 10. This eliminates the unseen middle portion 17 of FIG. 1.

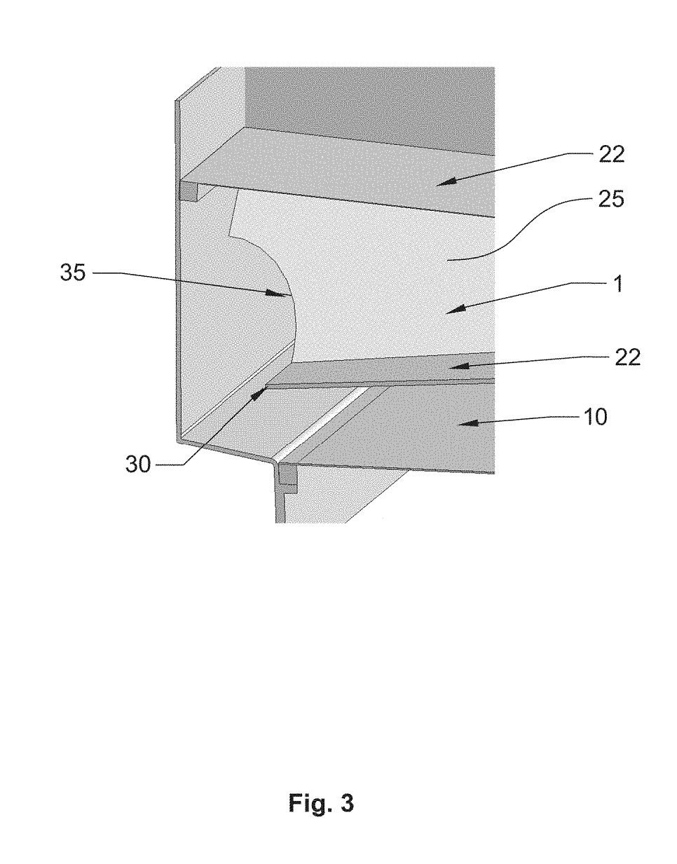

In FIG. 3 the backflow pan 1 is shown in cross-section from the side. Here, the downward angle of the pan 1 is shown. As fluid flows through the upper screen 5 and exits the distal side of the upper screen 5, it enters onto the bottom 22 of the backflow pan 1. The fluid goes down the bottom 22 of the pan 1 towards the distal side 30 of the pan 1 and then goes through the flow opening 35 where it goes to the lower screen 10. In some embodiments, the bottom 22 of the pan 1 can widen at the distal end of the pan 1 in order to distribute the flow more evenly on the lower screen 10. This widening of the bottom 22 can occur within the last few inches of the distal end of the pan 1.

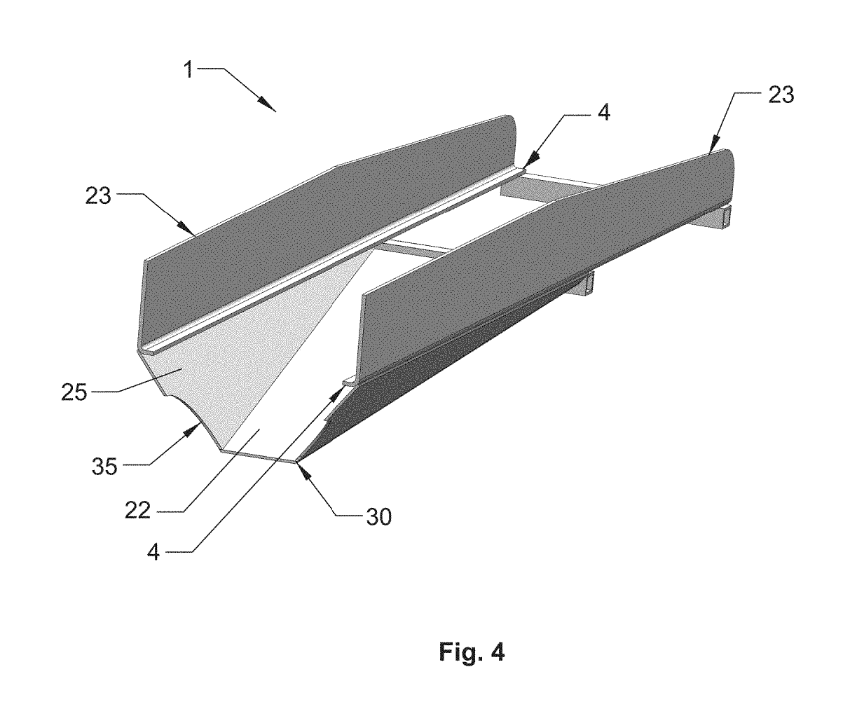

In FIG. 4 the backflow pan 1 has substantially vertical sides 23 contacting tapered sides 25. An upper screen (designated with the identifier 5 in FIGS. 1-3) can be placed onto the support 4. The screen can be porous allowing fluid to pass through the screen down to the bottom 22 of the backflow pan 1. There the bottom 22 of the pan 1 slants down toward the distal end 30 and has flow opening 35 that allow fluid to pass there through and reach the lower screen.

The vertical sides 23 and the tapered sides 25 can be made of one piece construction.

The backflow pan can be used or modified for use in the following patents and/or applications: U.S. Pat. No. 9,327,319; patent application Ser. No. 13/484,622 filed on May 31, 2012; application Ser. No. 12/925,724 filed Oct. 28, 2010 (now U.S. Pat. No. 8,960,446); application Ser. No. 14/630,611 filed Feb. 24, 2015; application Ser. No. 12/658,686 filed Feb. 16, 2010; application Ser. No. 12/804,546 filed Jul. 24, 2010.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A pan for use in a shaker, the pan having a first end and a second end with a length there between, the pan having a bottom with a width, narrowing side portions, an upper opening, and upper sides separated by an upper transverse width; the upper transverse width being wider than the width of the bottom, the narrowing side portions connecting the upper sides to the bottom, the bottom having a downward slant along the length between the first end and the second end.

2. The pan of claim 1 wherein the upper sides partially form the upper opening and extend substantially vertically down to the narrowing side portions.

3. The pan of claim 1 wherein the upper sides and the narrowing side portions are made of one piece construction.

4. The pan of claim 1 wherein the length of the pan is greater than the length of the narrowing side portions.

5. The pan of claim 1 wherein there are multiple narrowing side portions along the length of the pan.

6. The pan of claim 1 wherein the bottom of the pan widens at the distal end of the pan.

7. A shaker having at least two screens wherein a first screen is placed vertically above a second screen, a flowback pan disposed between the first screen and the second screen, the pan having a first end and a second end with a length there between, the pan having a bottom, narrowing side portions, an upper opening, and upper sides separated by a transverse width; the transverse width being wider than the bottom, the narrowing side portions connecting the upper sides to the bottom, the bottom having a downward slant along the length between the first side and the second side.

8. The shaker of claim 7 wherein the upper sides partially form the upper opening and extend substantially vertically down to the narrowing side portions.

9. The shaker of claim 7 wherein the upper sides and the narrowing side portions are made of one piece construction.

10. The shaker of claim 7 wherein the length of the pan is greater than the length of the narrowing side portions.

11. The shaker of claim 7 wherein there are multiple narrowing side portions along the length of the pan.
